(19) United States
(12) Patent Application Publication
(10) Pub. No.: US 2016/0108822 A1
(43) Pub. Date: Apr. 21, 2016

(54) CYLINDER DEACTIVATION APPARATUS OF ENGINE

(71) Applicant: HYUNDAI MOTOR COMPANY, Seoul (KR)

(72) Inventors: Hyoung Hyoun KIM, Gyeonggi-do (KR); Jang Su LEE, Gyeonggi-do (KR); Youngho KIM, Gyeonggi-do (KR); Jong Man JUN, Gyeonggi-do (KR)

(21) Appl. No.: 14/885,892

(22) Filed: Oct. 16, 2015

(30) Foreign Application Priority Data
Oct. 17, 2014 (KR) 10-2014-0141166

(51) Int. Cl. F02D 9/08; F02D 17/02

(52) U.S. Cl. CPC F02D 9/08; F02D 17/02

(57) ABSTRACT

A cylinder deactivation apparatus of an engine is configured to selectively deactivate at least one of a plurality of cylinders in accordance with operation states of an engine. The cylinders are configured to receive intake air from an intake manifold. The apparatus includes: at least one deactivation intake port having first and second ends. The first end communicates with the intake manifold. An intake channel connects the second end of the deactivation intake port to the at least one of the cylinders that is selectively deactivated. A deactivation throttle valve is disposed in the deactivation intake port and configured to selectively open or close the deactivation intake port. A controller is configured to control an operation of the deactivation throttle valve such that intake air is selectively supplied to the at least one of the cylinders.

### CROSS-REFERENCE TO RELATED APPLICATION

This application claims the benefit of priority to Korean Patent Application No. 10-2014-0141166 filed in the Korean Intellectual Property Office on Oct. 17, 2014, the entire contents of which are incorporated herein by reference.

### TECHNICAL FIELD

The present disclosure relates to a cylinder deactivation apparatus of an engine. More particularly, the present disclosure relates to a cylinder deactivation apparatus of an engine that allows for reduction of a manufacturing cost and has high operational reliability.

### BACKGROUND

In general, an internal combustion engine is an apparatus that operates using energy from heat generated by burning a gas mixture in a combustion chamber. As an internal combustion engine, a multi-cylinder engine with a plurality of cylinders for increasing power and reducing noise and vibration is generally used.

Recently, a cylinder deactivation apparatus of an engine that improves fuel efficiency by deactivating some of a plurality of cylinders in an engine when the engine generates a small amount of power has been developed with the increase in energy cost.

A way of deactivating cylinders used by such a cylinder deactivation apparatus is to operate an engine by injecting and burning a gas mixture in only some of the plurality of cylinders without injecting and igniting a gas mixture in the other cylinders.

For example, for a four-cylinder engine, the apparatus does not inject and ignite a gas mixture in two cylinders and operates the engine with only the other two cylinders.

However, according to the cylinder deactivation apparatus of the related art, there is a need for a variable valve lift technique to appropriately adjust valve lift, so the manufacturing cost of the cylinder deactivation apparatus increases. Further, when the valve lift is controlled hydraulically or electronically, the structure of an engine may be complicated and durability may be difficult to secure. Meanwhile, operational reliability may be deteriorated in control of the valve lift. Further, direct control of an intake valve may be disadvantageous in terms of reducing noise and shock.

The above information disclosed in this Background section is only for enhancement of understanding of the background of the invention and therefore it may contain information that does not form the prior art that is already known in this country to a person of ordinary skill in the art.

### SUMMARY

The present disclosure has been made in an effort to provide a cylinder deactivation apparatus of an engine that can easily attenuate noise and shock with a simple configuration while securing operational reliability.

Further, the present disclosure provides a cylinder deactivation apparatus of an engine that has high durability and can be manufactured at a low cost by having a simple configuration.

An exemplary embodiment of the present invention provides a cylinder deactivation apparatus of an engine. The apparatus can selectively deactivate at least one of a plurality of cylinders in accordance with an operation state of an engine. The cylinders may be configured to receive intake air from an intake manifold. The apparatus may include: at least one deactivation intake port having first and second ends. The first end may communicate with the intake manifold. An intake channel may connect the second end of the deactivation intake port to the at least one of the cylinders that is selectively deactivated. A deactivation throttle valve may be disposed in the deactivation intake port and may be configured to selectively open or close the deactivation intake port. A controller may be configured to control an operation of the deactivation throttle valve.

The controller may be configured to selectively open or close the deactivation intake port by operating the deactivation throttle valve in accordance with the operation state of the engine, such that intake air is selectively supplied to the at least one of the cylinders.

In certain embodiments, the deactivation throttle valve may include: a deactivation throttle body disposed in the deactivation intake port; a hinge member; and a plate portion having the shape of a flat plate disposed on the deactivation throttle body. The plate portion may be configured to selectively open or close the deactivation intake port by pivoting about the hinge member.

In certain embodiments, the intake channel may be divided and connected to at least two cylinders.

In certain embodiments, the apparatus may further include a fuel injector configured to supply fuel to the intake port or to the at least one of the cylinders. The fuel injector may be controlled by the controller to adjust the supply amount of the fuel in accordance with an operation state of the deactivation throttle valve.

In certain embodiments, the fuel injector may be configured to stop supplying the fuel when the deactivation throttle valve closes the deactivation intake port.

In certain embodiments, the fuel injector may be configured to supply the fuel when the deactivation throttle valve opens the deactivation intake port.

In certain embodiments, the deactivation throttle valve may duty-control an opening amount of the deactivation intake port.

In certain embodiments, the apparatus may further include a fuel injector configured to supply fuel to the intake port or to the at least one of the cylinders. The fuel injector may be controlled by the controller to supply fuel as according to the opening amount of the deactivation intake port.

### BRIEF DESCRIPTION OF THE DRAWINGS

FIG. 1 is a diagram illustrating the configuration of a cylinder deactivation apparatus of an engine according to an exemplary embodiment of the present invention, in which cylinders have been deactivated.

FIG. 2 is a diagram illustrating the configuration of the cylinder deactivation apparatus of an engine according to an exemplary embodiment of the present invention, in which cylinders have not been deactivated.

FIG. 3 is a diagram illustrating the configuration of a cylinder deactivation apparatus of an engine according to an exemplary embodiment of the present invention, in which cylinders have been duty-controlled.

### DETAILED DESCRIPTION

An exemplary embodiment of the present invention will hereinafter be described in detail with reference to the accompanying drawings.

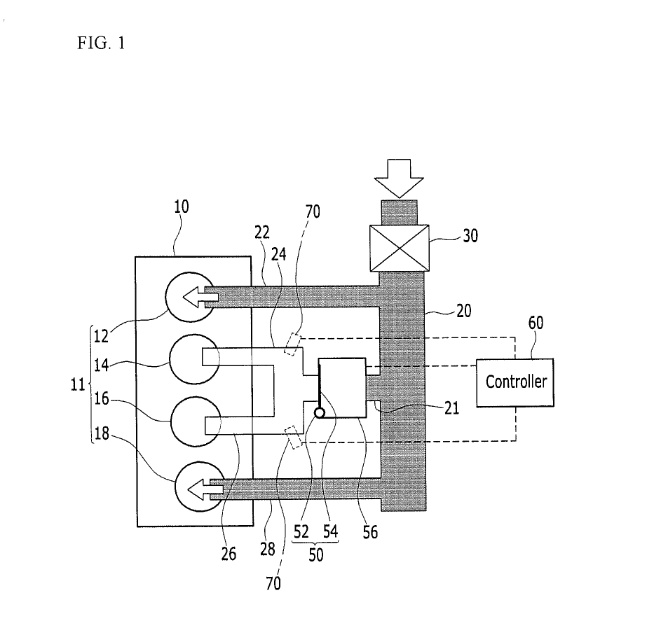

FIG. 1 is a diagram illustrating the configuration of a cylinder deactivation apparatus of an engine according to an exemplary embodiment of the present invention, in which cylinders have been deactivated.

As shown in FIG. 1, a cylinder deactivation apparatus according to an exemplary embodiment of the present invention includes a deactivation intake port 21, a deactivation throttle valve 50, and a controller 60. In certain embodiments, the deactivation throttle valve 50 includes a deactivation throttle body 56.

The deactivation intake port 21 has a first end that communicates with an intake manifold 20 that guides a gas mixture or air to cylinders 11 of an engine. An air throttle valve 30 that adjusts the amount of air flowing into the intake manifold 20 in accordance with the degree of operation of an accelerator pedal is disposed in the intake manifold 20. The air throttle valve 30 is well known to those skilled in the art, so the detailed description is not provided. Flow of air flowing into the intake manifold 20 and supplied to the cylinders 11 is indicated by arrows in FIGS. 1 to 3.

Although the cylinder deactivation apparatus shown in FIG. 1 is applied for a four-cylinder engine with four cylinders 11 in a cylinder block 10, the cylinder deactivation apparatus of an engine according to an exemplary embodiment of the present invention is not limited thereto. The cylinder deactivation apparatus may be applied to an engine having any number of cylinders.

For the convenience, the cylinder deactivation apparatus is applied to a four-cylinder engine in the following description, in which four cylinders 11 are referred to as, in order of arrangement, a first cylinder 12, a second cylinder 14, a third cylinder 16, and a fourth cylinder 18. Further, the intake channels diverging from the intake manifold 20 to the first cylinder 12, the second cylinder 14, the third cylinder 16, and the fourth cylinder 18, respectively, are referred to as a first intake channel 22, a second intake channel 24, a third intake channel 26, and a fourth intake channel 28.

In certain embodiments, the second intake channel 24 and the third intake channel 26 diverge from a second end of the deactivation intake port 21.

In certain embodiments, the deactivation throttle body 56 is disposed in the deactivation intake port 21 between the intake manifold 20 and the diverging point of the second intake channel 24 and the third intake channel 26.

In certain embodiments, the deactivation throttle valve 50 includes the deactivation throttle body 56. The deactivation throttle valve 50 opens/closes the deactivation intake port 21 or adjusts the amount of intake air flowing into the second intake channel 24 and the third intake channel 26 from the deactivation intake port 21.

In certain embodiments, the deactivation throttle valve 50 includes a hinge member 52 and a plate portion 54.

In certain embodiments, the hinge member 52 is a pivot shaft of the plate portion 54.

In certain embodiments, the plate portion 54 may be formed with a flat plate shape, and opens/closes the deactivation intake port 21 by pivoting on the hinge member 52. The amount of intake air flowing into the second intake channel 24 and the third intake channel 26 from the deactivation intake port 21 depends on the degree of opening of the deactivation intake port 21 by the plate portion 54.

In certain embodiments, the controller 60 is connected with the deactivation throttle body 56 and controls operation of the deactivation throttle valve 50 in accordance with operation states of an engine. That is, the controller 60 receives information about the operation states of an engine from various sensors (not shown), and performs control for opening or closing the deactivation intake port 21 in accordance with the information.

In certain embodiments, the cylinder deactivation apparatus of an engine according to an exemplary embodiment of the present invention may further include fuel injectors 70 that are controlled by the controller 60.

In certain embodiments, the fuel injectors 70, which are devices for supplying fuel to the cylinders 11, may be disposed in the second intake channel 24 and the third intake channel 26, separately from injectors (not shown) for supplying fuel to the first cylinder 12 and the fourth cylinder 18. Although the fuel injectors 70 are shown to be arranged to supply fuel into the second intake channel 24 and the third intake channel 26 in FIGS. 1 to 3, the present invention is not limited thereto, and the fuel injectors 70 may be arranged to supply fuel into the second cylinder 14 and the third cylinder 16 by those skilled in the art, if necessary.

The operation of the cylinder deactivation apparatus of an engine according to an exemplary embodiment of the present invention is described hereafter with reference to FIGS. 1 to 3. Intake air passing through the air throttle valve 30 and distributed to the cylinders is shown in FIGS. 1 to 3.

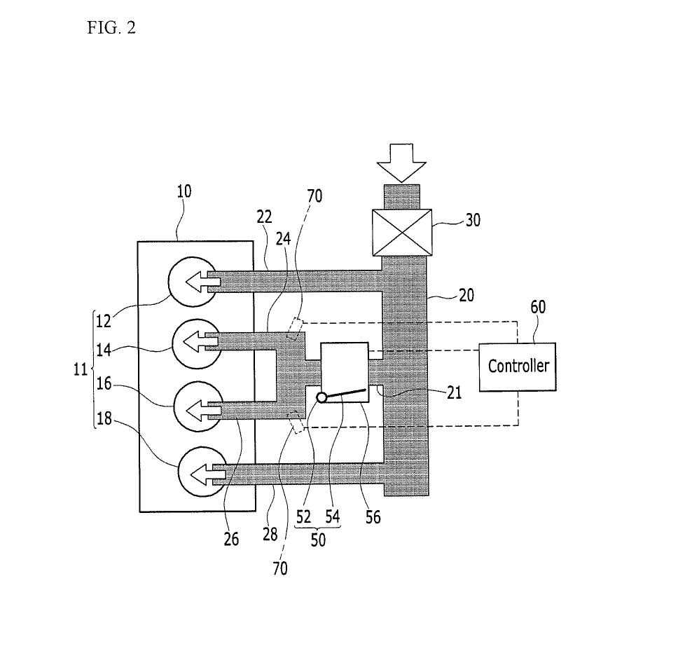

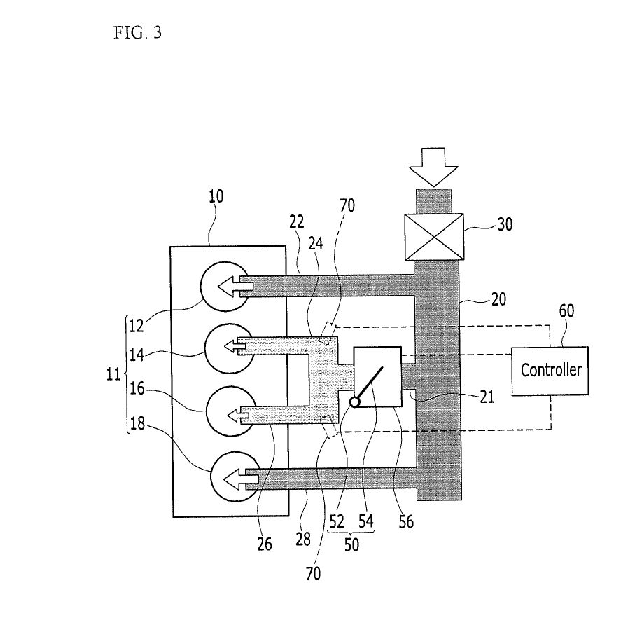

FIG. 2 is a diagram illustrating the configuration of the cylinder deactivation apparatus of an engine according to an exemplary embodiment of the present invention, in which cylinders have not been deactivated, and FIG. 3 is a diagram illustrating the configuration of a cylinder deactivation apparatus of an engine according to an exemplary embodiment of the present invention, in which cylinders have been duty-controlled.

As shown in FIG. 1, with the deactivation intake port 21 closed, intake air is not supplied to the second intake channel 24 and the third intake channel 26. That is, intake air is not supplied to the second cylinder 14 and the third cylinder 16. Further, when the deactivation intake port 21 is closed, the fuel injectors 70 are controlled to stop supplying fuel by the controller 60.

As shown in FIG. 2, with the deactivation intake port 21 open, intake air is supplied to the second intake channel 24 and the third intake channel 26, to the same as the first intake channel 22 and the fourth intake channel 28. That is, the second cylinder 14 and the third cylinder 16 are not deactivated. Further, with the deactivation intake port 21 open, the fuel injectors 70 are controlled to supply fuel to the second intake channel 24 and the third intake channel 26 by the controller 60.

As shown in FIG. 3, with the opening amount of the deactivation intake port 21 in duty control, the amount of intake air supplied to the second intake channel 24 and the third intake channel 26 is duty-controlled. That is, the amount of intake air to be supplied to the second cylinder 14 and the third cylinder 16 is controlled in accordance with the states of an engine. Although static duty control is shown in FIG. 3, the opening amount of the deactivation intake port 21 may be duty-controlled in several steps or continuously by those skilled in the art, if necessary. Further, in certain embodiments, as the opening amount of the deactivation intake port 21 is duty-controlled, the controller 60 controls the fuel injectors 70 to supply fuel, by as much as the amount of intake air supplied to the second intake channel 24 and the third intake channel 26, to the second intake channel 24 and the third intake channel 26 in accordance with the opening amount of the deactivation intake port 21. Therefore, an engine is prevented from consuming excess fuel and maintains optimal combustion.

Thus, in various embodiments of the cylinder deactivation apparatus, the controller may control the deactivation throttle valve to be fully closed, fully open, or partially open. In certain embodiments, the controller may keep the valve at a specific partial opening amount or may vary the opening amount of the valve continuously as needed.

According to an exemplary embodiment of the present invention, since the deactivation throttle valve 50 is provided, duty control of the amount of intake air can be performed and fuel efficiency can be improved. Further, since an intake valve is not directly used, it can be easy to attenuate shock and noise. Further, since a simple configuration of controlling only the deactivation throttle valve 50 is provided, the manufacturing cost can be reduced and the operational reliability can be secured.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A cylinder deactivation apparatus of an engine, the apparatus configured to selectively deactivate at least one of a plurality of cylinders in accordance with an operation state of an engine, the cylinders configured to receive intake air from an intake manifold, the apparatus comprising:
at least one deactivation intake port having first and second ends, the first end communicating with the intake manifold;
an intake channel connecting the second end of the deactivation intake port to the at least one of the cylinders that is selectively deactivated;
a deactivation throttle valve disposed in the deactivation intake port and configured to selectively open or close the deactivation intake port; and
a controller configured to control an operation of the deactivation throttle valve,
wherein the controller is configured to selectively open or close the deactivation intake port by operating the deactivation throttle valve in accordance with the operation state of the engine, such that intake air is selectively supplied to the at least one of the cylinders.

2. The apparatus of claim 1, wherein the deactivation throttle valve comprises:
a deactivation throttle body disposed in the deactivation intake port;
a hinge member; and
a plate portion having the shape of a flat plate disposed on the deactivation throttle body, and configured to selectively open or close the deactivation intake port by pivoting about the hinge member.

3. The apparatus of claim 1, wherein the at least one of the cylinders includes at least two cylinders, and the intake channel is divided and connected to the at least two cylinders.

4. The apparatus of claim 1, further comprising
a fuel injector configured to supply fuel to the deactivation intake port or to the at least one of the cylinders,
wherein the fuel injector is controlled by the controller to adjust a supply amount of the fuel in accordance with an operation state of the deactivation throttle valve.

5. The apparatus of claim 4, wherein the fuel injector is configured to stop supplying the fuel when the deactivation throttle valve closes the deactivation intake port.

6. The apparatus of claim 4, wherein the fuel injector is configured to supply the fuel when the deactivation throttle valve opens the deactivation intake port.

7. The apparatus of claim 1, wherein the deactivation throttle valve duty-controls an opening amount of the deactivation intake port.

8. The apparatus of claim 7, further comprising a fuel injector configured to supply fuel to the intake port or to the at least one of the cylinders,
wherein the fuel injector is controlled by the controller to supply fuel according to the opening amount of the deactivation intake port.
